(19) United States
(12) Patent Application Publication
(10) Pub. No.: US 2010/0172654 A1
(43) Pub. Date: Jul. 8, 2010

(54) LIGHT EMITTING ELEMENT CIRCUIT, LIGHT TRANSMITTING SYSTEM, LIGHT TRANSMITTING MODULE, AND ELECTRONIC DEVICE

(75) Inventors: Akira Enami, Kyoto (JP); Toshiaki Okuno, Kyoto (JP); Akihiko Sano, Kyoto (JP); Yoshihisa Ishida, Kyoto (JP); Junichiro Yamada, Kyoto (JP); Naru Yasuda, Kyoto (JP); Hayami Hosokawa, Kyoto (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto (JP)

(21) Appl. No.: 12/297,151

(22) PCT Filed: Apr. 26, 2007
(86) PCT No.: PCT/JP2007/059036

§ 371 Date: Oct. 14, 2008

(30) Foreign Application Priority Data
Apr. 28, 2006 (JP) 2006-127006

(51) Int. Cl. H04B 10/04; H01S 3/10; H05B 37/02

(52) U.S. Cl. 398/183; 372/38.01; 315/309; 372/45.01

(57) ABSTRACT

A light emitting element circuit has a light emitting element, a drive circuit that supplies a current to the light emitting element, and a signal circuit that autonomously supplies a signal according to an ambient temperature. The signal adjusts the current such that the current corresponds to a temperature characteristic of the light emitting element.

### TECHNICAL FIELD

The present invention relates to output control of a light emitting element used in a light transmitting module or the like.

### BACKGROUND ART

A semiconductor light emitting element such as a laser diode (LD) is used in a light transmitting module. The semiconductor light emitting element converts an electric signal into an optical signal to supply the optical signal to an optical fiber and the like. Usually the semiconductor light emitting element has a temperature characteristic. For example, a drive current-output characteristic (1-P characteristic) of the laser diode depends on a temperature, and a threshold current or a gradient (SE) of the I-P characteristic is changed by a temperature. Accordingly, in order to control an optical output of the laser diode at a constant level, it is necessary to adjust a drive current according to a temperature.

Patent Document 1 discloses a configuration for controlling the optical output of the laser diode. Specifically, an optical transmitter disclosed in Patent Document 1 includes a laser diode, a drive circuit which drives the laser diode, a feedback circuit, and a temperature sensor. The feedback circuit includes a monitor Photo-Diode (PD), a computation processing circuit, a memory unit, and an optical output monitor signal generation unit. Pieces of temperature characteristic information on the laser diode, the drive circuit, and the monitor PD are stored in the memory unit. The optical output monitor signal generation unit generates an optical output monitor signal based on a signal supplied from the monitor PD.

In the feedback circuit of the optical transmitter, a computation processing unit receives the optical output monitor signal supplied from the optical output monitor signal generation unit and a temperature monitor signal supplied from the temperature sensor, and the computation processing unit reads the temperature characteristic information stored in the memory unit, and the computation processing unit generates a control signal for controlling each of values of drive currents (modulation current Imod and threshold current Ith). When receiving the control signal, the drive circuit adjusts the drive currents such that the optical output of the laser diode is kept constant (target value).

Patent Document 1: WO2002/069464 (published data of Sep. 6, 2002)

However, in the above configuration, the feedback circuit including the monitor Photo-Diode (PD), the computation processing circuit, the memory unit, and the optical output monitor signal generation unit is required, which results in an enlarged optical transmitter. Additionally, power consumption becomes troublesome in the feedback circuit. This is especially the case in a data transmission module for a mobile device (such as portable telephone) in which a compact size and low power consumption are demanded.

One or more embodiments of the present invention provides a compact, low power-consumption light transmitting module.

### DISCLOSURE OF THE INVENTION

A light emitting element circuit according to one or more embodiments of the present invention includes a light emitting element; a drive circuit which supplies a current to the light emitting element; and a signal circuit which autonomously supplies a signal according to an ambient temperature, the light emitting element circuit is characterized in that the signal adjusts the current such that the current corresponds to a temperature characteristic of the light emitting element.

In the light emitting element circuit according to one or more embodiments of the present invention, the signal can set the current supplied to the light emitting element at a value suitable to the temperature characteristic of the light emitting element. Therefore, an excessive margin can be reduced to realize the low power consumption. Additionally, because the signal circuit according to one or more embodiments of the present invention autonomously supplies the signal, the feedback circuit, the computation processing circuit, and the memory circuit can be eliminated to further achieve the low power consumption and the compact module.

### BRIEF DESCRIPTION OF THE DRAWINGS

FIG. 1 is a block diagram showing a configuration of a transmission unit of a light transmitting module according to one or more embodiments of the present invention.

FIG. 2 is a block diagram showing a specific example of the transmission unit.

FIG. 3 is a circuit diagram showing a specific example of a first-signal generation circuit.

FIG. 4 is a circuit diagram showing a specific example of a second-signal generation circuit.

FIG. 5 is a table showing a temperature characteristic of a circuit element (resistor) provided in the first-signal generation circuit.

FIG. 6 is a graph showing a temperature characteristic of a circuit element (resistor) provided in the first-signal generation circuit.

FIG. 7 is a graph showing a temperature characteristic of a collector current in the second-signal generation circuit.

FIG. 8 is a graph showing a temperature characteristic of an emitter-collector voltage in the second-signal generation circuit.

FIG. 9 is a circuit diagram showing a specific example of a drive circuit.

FIG. 10 is a graph showing a temperature characteristic of amplitude of a modulation current Imod supplied to a light emitting element.

FIG. 11 is a graph showing a temperature characteristic of a modulation current Ibias supplied to the light emitting element.

FIGS. 12(a) and 12(b) are graphs showing temperature characteristics of the modulation current Imod and bias current Ibias in an embodiment of the present invention.

FIG. 13 is a schematic view showing a configuration of the light transmitting module according to one or more embodiments of the present invention.

FIG. 14 is a graph showing dependence of a current-output characteristic on a temperature of a light emitting element (VCSEL).

FIG. 15 is a graph showing a temperature characteristic of a threshold current of the light emitting element (VCSEL).

FIG. 16 is a graph showing dependence of SE (gradient of current-output characteristic) on a temperature of the light emitting element (VCSEL).

FIG. 17 is a block diagram showing a modification of the transmission unit of the light transmitting module according to one or more embodiments of the present invention.

FIG. 18 is a block diagram showing another modification of the transmission unit.

FIG. 19 is a block diagram showing another modification of the transmission unit.

FIG. 20 is a block diagram showing another modification of the transmission unit.

FIG. 21 is a schematic view explaining a cavity length of VCSEL.

FIG. 22(a) is a perspective view showing an appearance of a printer provided with a light transmitting module according to an embodiment of the present invention, FIG. 22(b) is a block diagram showing a main part of the printer shown in FIG. 22(a), and FIGS. 22(c) and 22(d) are perspective views showing a state in which an optical transmission line (optical waveguide) is bent when a printhead is moved (driven) in the printer.

FIG. 23(a) is a perspective view showing an appearance of a foldable portable telephone provided with the light transmitting module, FIG. 23(b) is a block diagram showing a portion to which the light transmitting module is applied in the foldable portable telephone shown in FIG. 23(a), and FIG. 23(c) is a perspective plan view showing a hinge portion in the foldable portable telephone shown in FIG. 23(a).

FIG. 24 is a perspective view showing an appearance of a hard disk recording and reproducing apparatus provided with the light transmitting module according to one or more embodiments of the present invention.

### BEST MODES FOR CARRYING OUT THE INVENTION

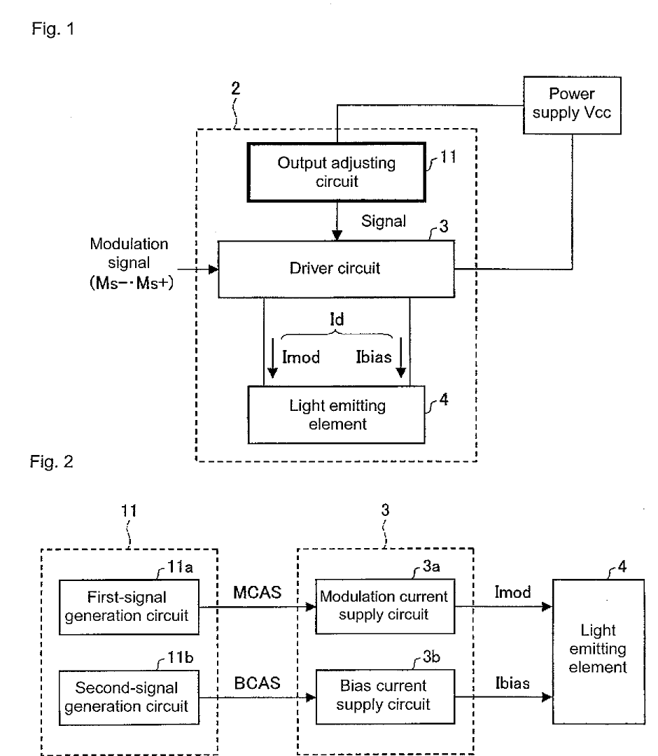

An embodiment of the present invention will be described below with reference to FIGS. 1 to 20. FIG. 13 is a block diagram showing a configuration example of a light transmitting module according to one or more embodiments of the present invention. As shown in FIG. 13, a light transmitting module 1 includes a transmission unit 2, an optical waveguide 8, and a reception unit 5. The transmission unit 2 includes a (transmitting) light emitting element 4 in which, for example, a VCSEL is used, an output adjusting circuit 11 (signal circuit), and a driver circuit 3 (drive circuit). The reception unit 5 includes a (receiving) light acceptance element 6 such as a PD and an amplifier circuit 7.

The output adjusting circuit 11 and the driver circuit 3 are connected to a power supply Vcc. For example, the optical waveguide (optical transmission line) 8 is a polymer waveguide. Preferably the optical waveguide 8 has flexibility. For example, the light transmitting module 1 is preferably used in data transmission between a CPU board and an LCD board of the portable telephone.

FIG. 1 is a block diagram showing a specific example of the transmission unit. As shown in FIG. 1, in the transmission unit 2, a modulation signal (Ms− and Ms+) supplied from a CPU or the like and a signal supplied from the output adjusting circuit 11 are fed into the driver circuit 3. At this point, the output adjusting circuit 11 autonomously supplies a signal according to an ambient temperature irrespective of the external control (such as a feedback circuit or a computation processing circuit of light emitting element). The driver circuit 3 generates a modulation current Imod and a bias current Ibias, and the driver circuit 3 supplies the sum of the modulation current Imod and the bias current Ibias to the light emitting element 4 in the form of a drive current Id.

FIG. 2 is a block diagram showing more specifically the transmission unit. As shown in FIG. 2, the output adjusting circuit 11 includes a first-signal generation circuit and a second-signal generation circuit, and the driver circuit 3 includes a modulation-current supply circuit 3a and a bias-current supply circuit 3b.

The first-signal generation circuit 11a autonomously supplies a first signal MCAS according to a temperature. The modulation-current supply circuit 3a receives the first signal MCAS to generate the modulation current Imod corresponding to the temperature, and supplies the modulation current Imod to the light emitting element 4. That is, the first signal MCAS directly adjusts the modulation current Imod generated by the modulation-current supply circuit 3a.

The second-signal generation circuit 11b autonomously supplies a second signal BCAS according to the temperature. The bias-current supply circuit 3b receives the second signal BCAS to generate the bias current Ibias corresponding to the temperature, and supplies the bias current Ibias to the light emitting element 4. That is, the second signal BCAS directly adjusts the modulation current Ibias generated by the modulation-current supply circuit 3b.

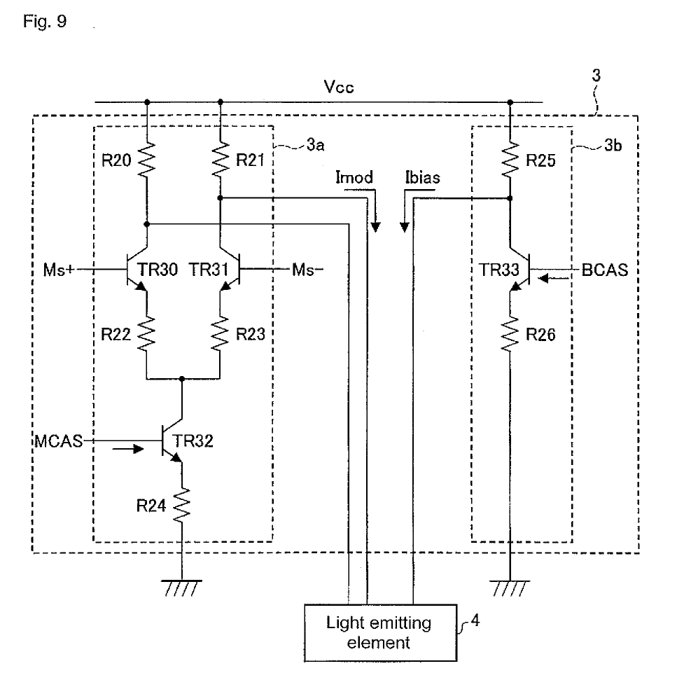

FIG. 9 is a specific example of a driver circuit including the modulation-current supply circuit and the bias-current supply circuit.

As shown in FIG. 9, the modulation-current supply circuit 3a includes resistors R20 to R24 and NPN-type bipolar transistors TR30 to 32. In the transistor TR30, a collector is connected to a Vcc through the resistor R20, and an emitter is connected to a collector of the transistor TR32 through the resistor R22. The modulation signal Ms+ is fed into a base of the transistor TR30. In the transistor TR31, a collector is connected to the Vcc through the resistor R21, and an emitter is connected to the collector of the transistor TR32 through the resistor R23. The modulation signal Ms− is fed into a base of the transistor TR31. Further, an emitter of the transistor TR32 is connected to GND through the resistor R24, and the first signal MCAS is fed into a base of the transistor TR32. In the above configuration, the transistors TR30 and TR31 convert the modulation signal into a current, and the transistor TR32 amplifies the current based on the first signal (MCAS). Therefore, the modulation current Imod is taken out from a node between the resistor R20 and the collector of the transistor R30 or a node between the resistor R21 and the collector of the transistor R31.

As shown in FIG. 9, the bias-current supply circuit 3b includes resistors R25 and R26 and an NPN-type bipolar transistor TR33. In the transistor TR33, a collector is connected to the Vcc through the resistor R25, and an emitter is connected to the GND through the resistor R26. The second signal BCAS is fed into a base of the transistor TR33. In the configuration, the transistor TR33 amplifies the current from the Vcc based on the second signal BCAS. Therefore, the bias current Ibias is taken out from a node between the resistor R25 and the collector of the transistor R33.

In the embodiment, the first signal MCAS corresponding to the temperature automatically controls (adjusts) the modulation current Imod such that the modulation current Imod corresponds to a temperature characteristic of the transmitting light emitting element 4, and second signal BCAS corresponding to the temperature automatically controls (adjusts) the bias current Ibias such that the bias current Ibias corresponds to the temperature characteristic of the transmitting light emitting element 4.

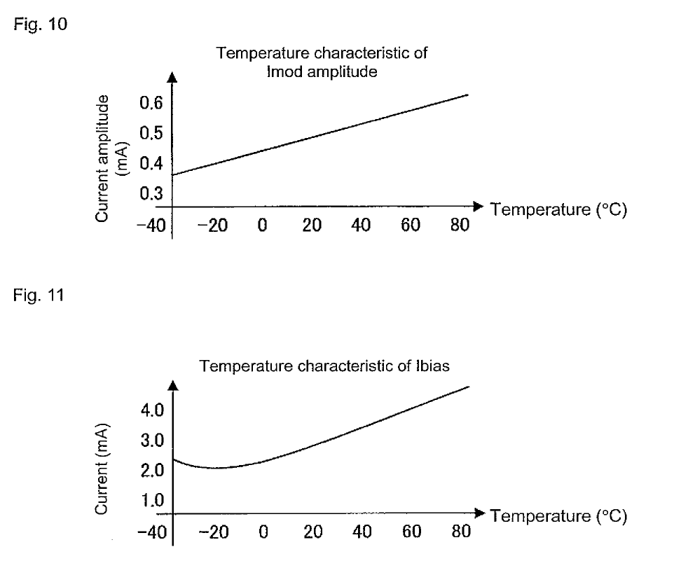

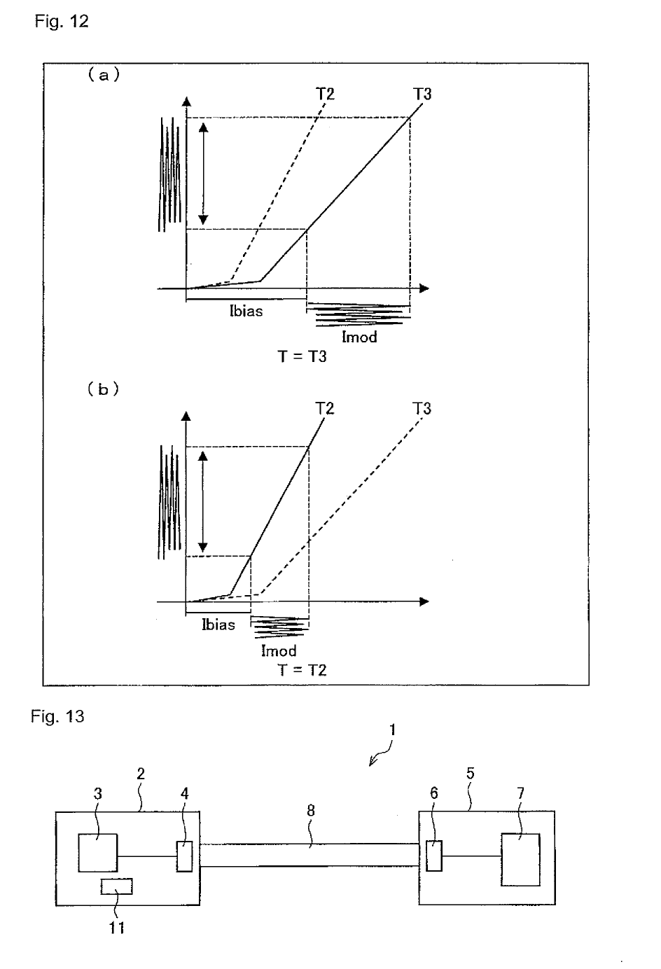

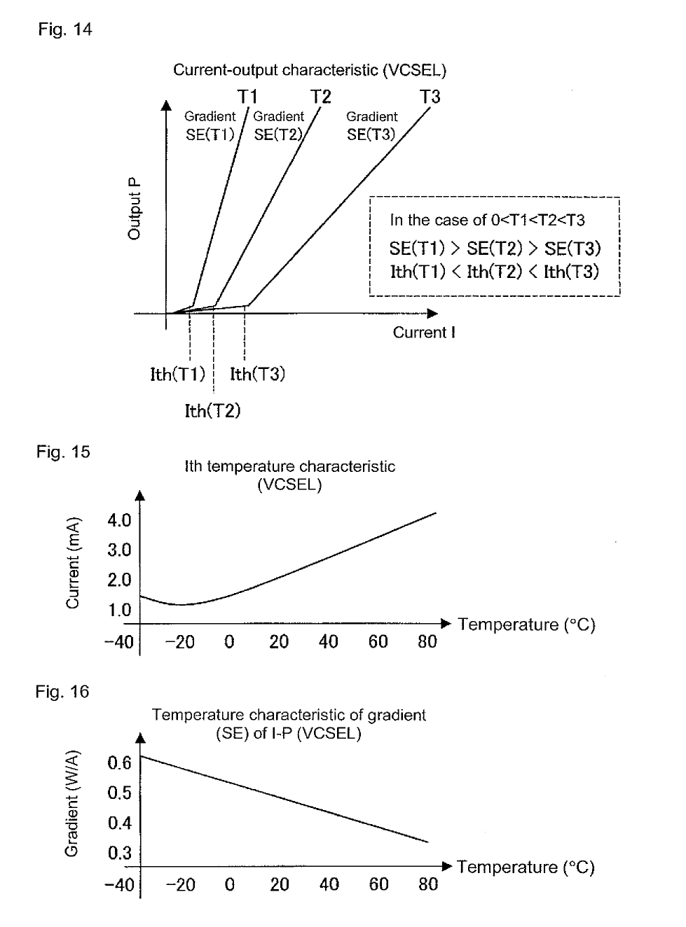

That is, the light emitting element 4 in which VCSEL is used has the temperature characteristic, a threshold current Ith of the light emitting element 4 is changed along a downwardly-convex quadratic curve having an axis near −30 (° C.) with respect to the temperature (see FIGS. 14 and 15), and a gradient (SE) of a current-output (I-P) characteristic is linearly decreased with respect to the temperature (see FIGS. 14 and 16). In the embodiment, in order to correspond to the temperature characteristic of the light emitting element 4, the modulation current Imod has a temperature characteristic in which the amplitude is linearly increased with respect to the temperature (see FIG. 10), and the bias current Ibias has a temperature characteristic in which the bias current Ibias is changed (that is, gradually increased in a practical temperature range) along a downwardly convex quadratic curve having the axis near −30 (° C.) with respect to the temperature (see FIG. 11). For example, in the case of 0<T2<T3, as shown in FIGS. 12(a) and 12(b), the amplitude of the modulation current Imod at T3 is larger than the amplitude of the modulation current Imod at T2, and the bias current Ibias at T3 is larger than the bias current Ibias at T2.

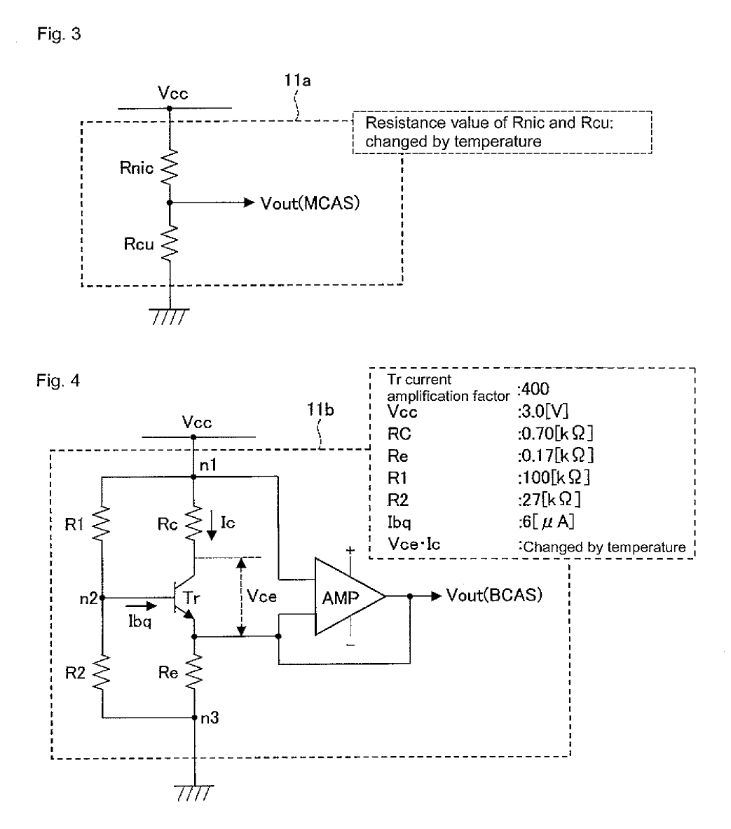

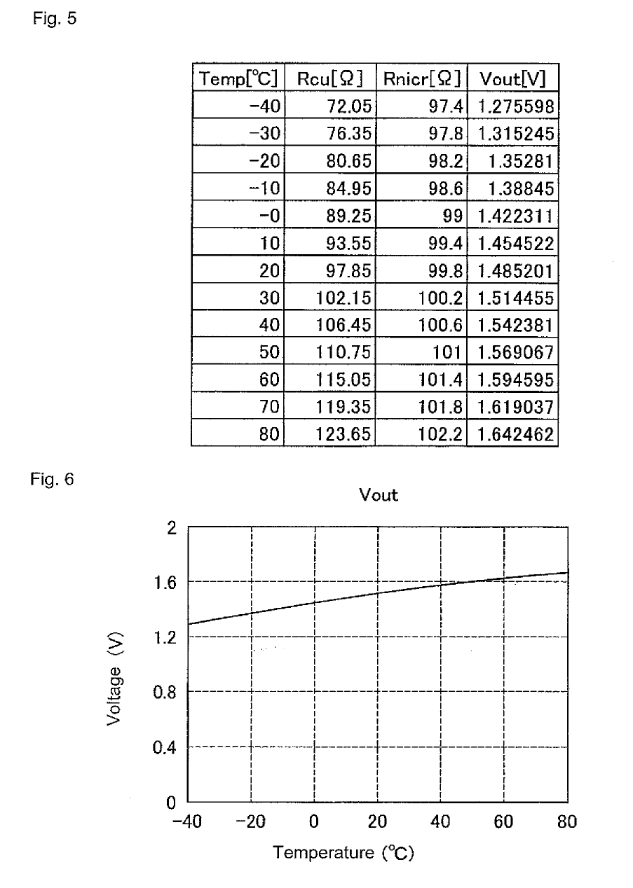

At this point, the first-signal generation circuit 11a autonomously supplies the first signal MCAS that is capable of directly adjusting the modulation current Imod such that the modulation current Imod has the above-described temperature characteristic. Therefore, for example, the first-signal generation circuit 11a is configured as shown in FIG. 3. That is, the first-signal generation circuit 11a has a configuration in which resistors Rnicr and Rcu are connected in series between the power supply Vcc and GND, and the first signal MCAS is taken out as an output (Vout) from a node between the resistors Rnicr and Rcu. The resistors Rnicr and Rcu have temperature characteristics, and a resistance value of each of the resistors (Rcu and Rnicr) are changed by the temperature as shown in FIG. 5, whereby Vout (first signal MCAS) is linearly (monotonously) increased with respect to the temperature (see FIG. 6).

On the other hand, the second-signal generation circuit 11b autonomously supplies the second signal BCAS that is capable of directly adjusting the bias current Ibias such that the bias current Ibias has the above-described temperature characteristic. Therefore, for example, the second-signal generation circuit 11b is configured as shown in FIG. 4. That is, the second-signal generation circuit 11b includes a transistor Tr, a resistor Rc, a resistor Re, resistors R1 to R2, and an operational amplifier (AMP). In the transistor Tr, a collector is connected to a node n1 through the resistor Rc, an emitter is connected to a node n3 through the resistor Re, and a base is connected to a node n2. The node n1 is connected to the Vcc, the resistor R1 is provided between the nodes n1 and n2, and the resistor R2 is provided between the nodes n2 and n3. Further, the node n1 and the emitter of the transistor Tr are connected to inputs of the operational amplifier in which negative feedback is established, and the second signal BCAS is taken out as the output (Vout) of the operational amplifier. Alternatively, the node n3 and the collector of the transistor Tr may be connected to the inputs of the operational amplifier in which the negative feedback is established.

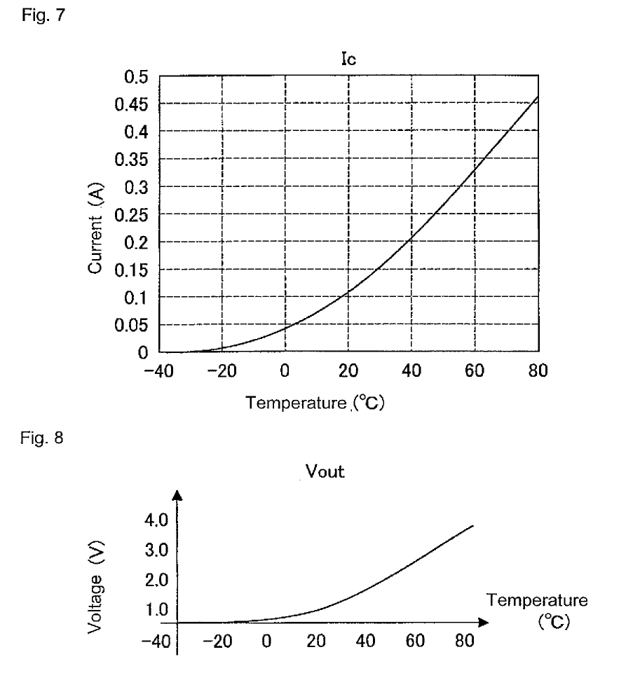

The resistance values shown in FIG. 4 of the resistor Rc, resistor Re, and resistors R1 and R2 are independent of the temperature. However, the transistor Tr has a temperature characteristic, and a current Ic passed through the resistor Rc is changed according to the temperature as shown in FIG. 7. Therefore, as shown in FIG. 8, Vout (second signal BCAS) is changed along a downwardly-convex quadratic curve having an axis near −30° C. (that is, gradually increased in the practical temperature range).

Thus, in the transmission unit 2 of the light transmitting module 1, the bias current Ibias and the modulation current Imod are adapted to the temperature characteristic of the light emitting element 4, so that the excessive margin can be reduced to realize the low power consumption. Additionally, the feedback circuit including PD, the computation processing circuit, and the memory circuit can be eliminated to further achieve the low power consumption and the compact module.

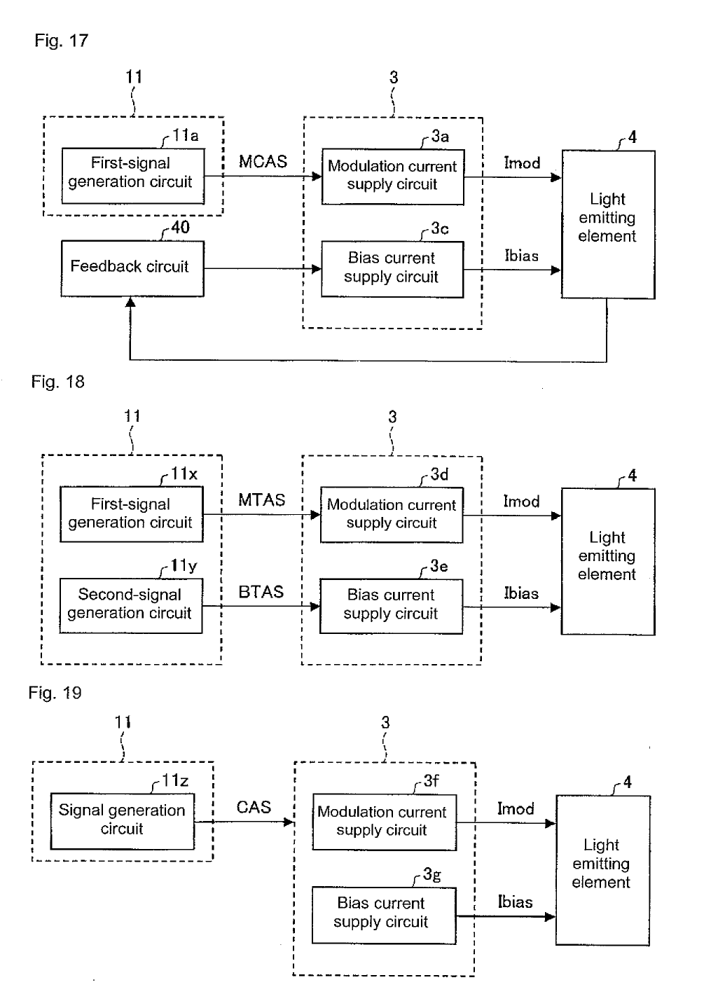

The transmission unit 2 of the light transmitting module 1 can also be configured as shown in FIG. 17. That is, the feedback adjustment is performed to the bias current. As shown in FIG. 17, the transmission unit 2 includes the output adjusting circuit 11, the driver circuit 3, and a feedback circuit 40. The output adjusting circuit 11 includes the first-signal generation circuit 11a, and the driver circuit 3 includes the modulation-current supply circuit 3a and a bias-current supply circuit 3c. The first-signal generation circuit 11a autonomously supplies the first signal MCAS according to the temperature. The modulation-current supply circuit 3a receives the first signal MCAS to generate the modulation current Imod corresponding to the temperature, and supplies the modulation current Imod to the light emitting element 4. The bias-current supply circuit 3c receives a signal supplied from the feedback circuit 40 to generate the bias current Ibias corresponding to the output of the light emitting element 40, and supplies the bias current Ibias to the light emitting element 4. That is, the first signal MCAS directly adjusts the modulation current Imod.

The transmission unit 2 of the light transmitting module 1 can also be configured as shown in FIG. 18. That is, a temperature sensor (not shown) is provided in the output adjusting circuit 11. As shown in FIG. 19, the output adjusting circuit 11 includes a first-signal generation circuit 11x which has a temperature sensor and a second-signal generation circuit 11y which has a temperature sensor, and the driver circuit 3 includes a modulation-current supply circuit 3d and a bias-current supply circuit 3e. The first-signal generation circuit 11x autonomously supplies a first signal MTAS according to the temperature. The modulation-current supply circuit 3d receives the first signal MTAS to generate the modulation current Imod corresponding to the temperature, and supplies the modulation current Imod to the light emitting element 4. That is, the first signal MTAS directly adjusts the modulation current Imod. The second-signal generation circuit 11y autonomously supplies a second signal BTAS according to the temperature. The modulation-current supply circuit 3e receives the second signal BTAS to generate the bias current (bias corresponding to the temperature, and supplies the bias current Ibias to the light emitting element 4. That is, the second signal BTAS directly adjusts the bias current Ibias.

The transmission unit 2 of the light transmitting module 1 can also be configured as shown in FIG. 19. That is, the signal supplied from the output adjusting circuit 11 is shared. As shown in FIG. 19, the output adjusting circuit 11 includes a signal generation circuit 11z, and the driver circuit 3 includes a modulation-current supply circuit 3f and a bias-current supply circuit 3g. The signal generation circuit 11z autonomously supplies a (common) signal CAS according to the temperature. The modulation-current supply circuit 3f receives the signal CAS to generate the modulation current Imod corresponding to the temperature, and supplies the modulation current Imod to the light emitting element 4. Further, the modulation-current supply circuit 3e receives the (common) signal CAS to generate the bias current Ibias corresponding to the temperature, and supplies the bias current Ibias to the light emitting element 4. That is, the signal CAS directly adjusts the modulation current Imod and the bias current Ibias.

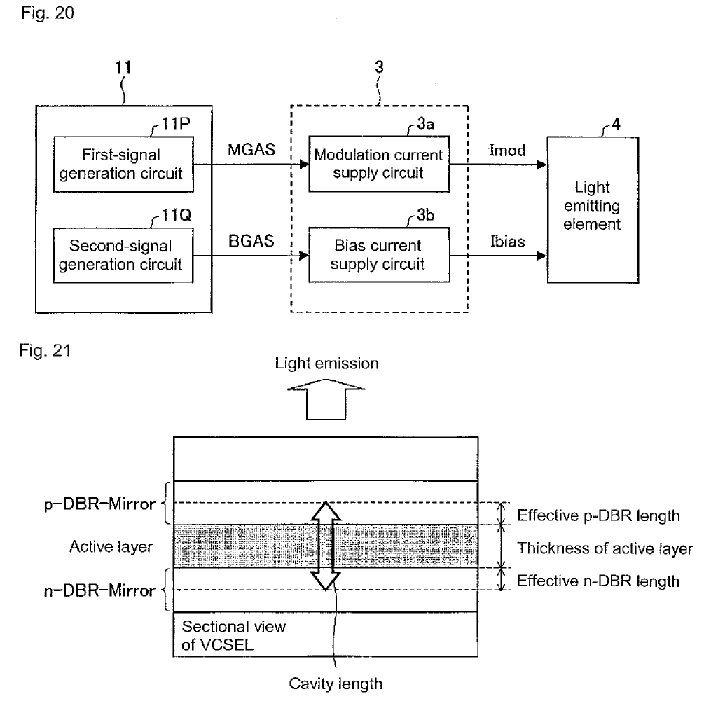

The transmission unit 2 of the light transmitting module 1 can also be configured as shown in FIG. 20. That is, the output adjusting circuit 11 is configured in consideration of not only the temperature characteristic of the light emitting element 4 but also the temperature characteristic (for example, temperature characteristic of conversion efficiency of the photodiode) of the light acceptance element of the reception unit. As shown in FIG. 20, the output adjusting circuit 11 includes a first-signal generation circuit 11P and a second-signal generation circuit 11Q, and the driver circuit 3 includes the modulation-current supply circuit 3a and the bias-current supply circuit 3b. The first-signal generation circuit 11P autonomously supplies a first signal MGAS according to the temperature in consideration of the temperature characteristic of the light acceptance element. The modulation-current supply circuit 3a receives the first signal MGAS to generate the modulation current Imod corresponding to the temperature, and supplies the modulation current Imod to the light emitting element 4. That is, the first signal MGAS directly adjusts the modulation current Imod.

The second-signal generation circuit 11Q autonomously supplies a second signal BGAS according to the temperature in consideration of the temperature characteristic of the light acceptance element. The bias-current supply circuit 3b receives the second signal BGAS to generate the bias current Ibias corresponding to the temperature, and supplies the bias current Ibias to the light emitting element 4. That is, the second signal BGAS directly adjusts the bias current Ibias. Therefore, the modulation current Imod and the bias current Ibias can be generated in consideration of the temperature characteristic of the light acceptance element, so that power saving can further be realized in the light transmitting module.

In a VCSEL used in the light emitting element 4, preferably a cavity length (cavity length=effective p-DBR length-thickness of active layer+effective n-DBR length, see FIG. 21) is set such that the threshold current is linearly increased with respect to the temperature.

In the case where the transmission unit 2 is configured, preferably the light emitting element 4 and the output adjusting circuit 11 are brought close to each other as much as possible. For example, a distance between the light emitting element 4 and the output adjusting circuit 11 is set within 10 mm. A laser diode (LD), an organic EL, an LED, or the like may be used as the light emitting element of the transmission unit.

The light transmitting module can be applied to various electronic devices as follows.

For a first application example, the light transmitting module can be used in a hinge portion in foldable electronic devices such as a foldable portable telephone, a foldable PHS (Personal Handyphone System), a foldable PDA (Personal Digital Assistant), and a foldable notebook personal computer. In such cases, preferably flexibility is imparted to the optical waveguide (optical transmission line) of the light transmitting module.

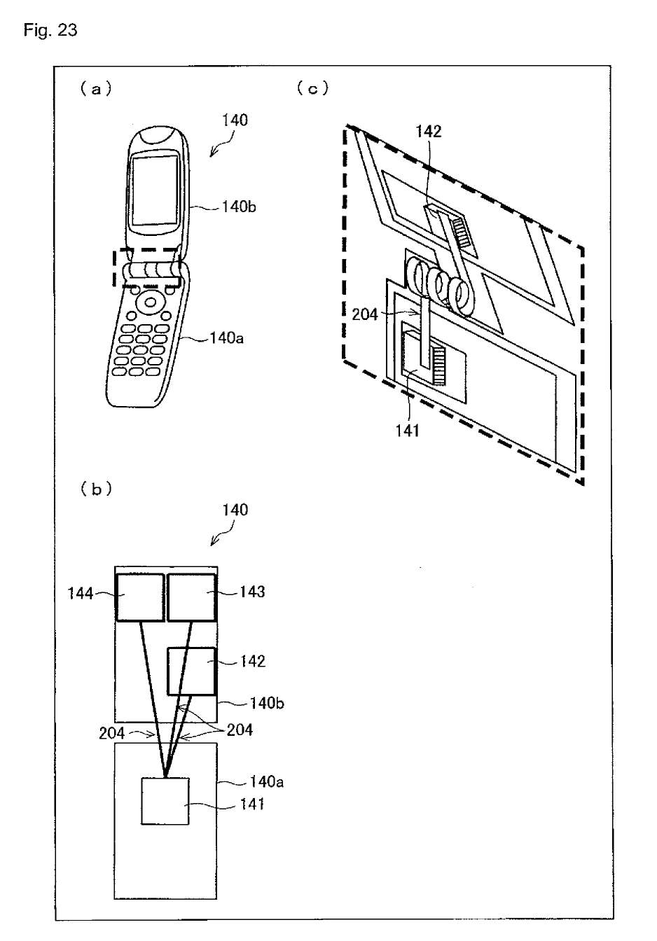

FIGS. 23(a) to 23(c) show an example in which the light transmitting module is applied to a foldable portable telephone. That is, FIG. 23(a) is a perspective view showing an appearance of the foldable portable telephone in which the light transmitting module is incorporated. FIG. 23(b) is a block diagram showing a portion to which the light transmitting module is applied in the foldable portable telephone shown in FIG. 23(a). As shown in FIG. 23(b), a control unit 141, an external memory 142, a camera unit (digital camera) 143, and a display unit (liquid crystal display) 144 are connected by a light transmitting module 104. The control unit 141 is provided on a side of a main body 140a in a foldable portable telephone 140. The external memory 142 is provided on a side of a cover (drive unit) 140b, and the cover 140b is provided at one end of the main body while being rotatable about the hinge portion.

FIG. 23(c) is a perspective plan view showing a hinge portion (surrounded by a broken line) of FIG. 23(a). As shown in FIG. 23(c), the light transmitting module 104 is bent while wrapped around a support rod in the hinge portion, thereby connecting the control unit provided on the main body side, the external memory 142 provided on the cover side, the camera unit 143, and the display unit 144.

The high-speed and large-capacity communication can be realized in a limited space by applying the light transmitting module 104 to the foldable electronic devices. Accordingly, the light transmitting module is particularly suitable to the instrument such as the foldable liquid crystal display in which the high-speed and large-capacity communication and the compact size are demanded.

For a second application example, the light transmitting module can be applied to an apparatus provided with a drive unit, such as a printhead of a printer (electronic device) and a reading unit of a hard disk recording and reproducing apparatus. In such cases, the flexibility is imparted to the optical waveguide (optical transmission line) of the light transmitting module.

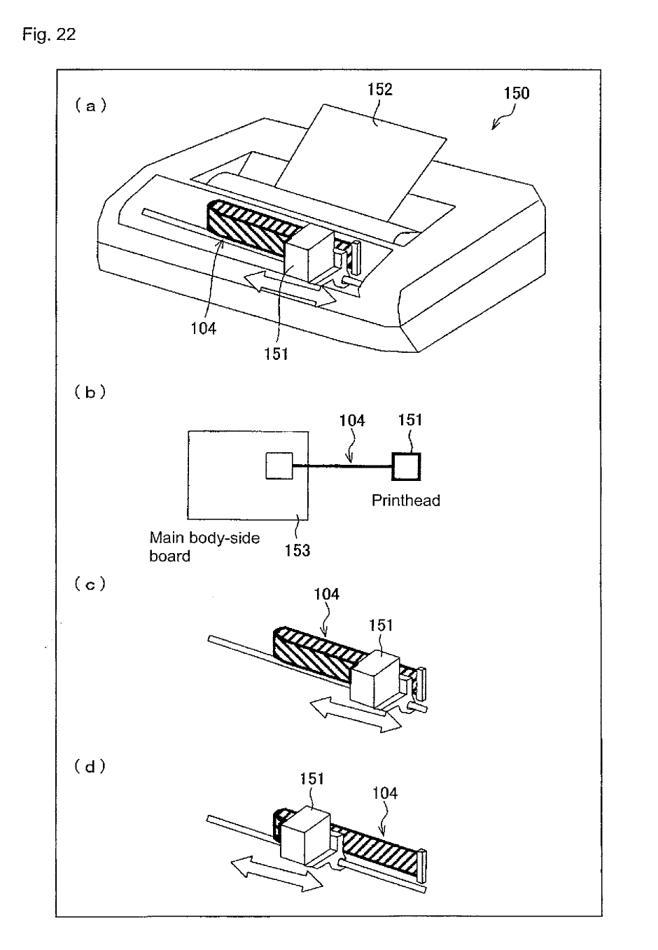

FIGS. 22(a) to 22(d) show an example in which the light transmitting module is applied to a printer. FIG. 22(a) is a perspective view showing an appearance of the printer. As shown in FIG. 22(a), a printer 150 includes a printhead 151, and the printhead 151 performs printing to a sheet 152 while being moved in a width direction of the sheet 152. One end of a light transmitting module 204 is connected to the printhead 151.

FIG. 22(b) is a block diagram showing a portion to which the light transmitting module is applied in the printer. As shown in FIG. 22(b), one (for example, reception unit 5) of end portions of the light transmitting module 204 is connected to the printhead 151, and the other end portion (for example, transmission unit 2) is connected to a main body-side board of the printer 150. Control means for controlling an operation of each unit of the printer 150 is provided in the main body-side board.

FIGS. 22(c) and 22(d) are perspective views showing a state in which the optical transmission line of the optical transmitting module is bent when the printhead is moved (driven) in the printer. As shown in FIGS. 22(c) and 22(d), in the case where the light transmitting module 204 is applied to the drive unit such as the printhead 151, the bent state of the optical transmission line is changed by the drive of the printhead 151, and the optical transmission line is repeatedly bent at each position.

At this point, because the optical transmission line of the light transmitting module 204 has the flexibility, the light transmitting module is suitable to the drive unit. Further, the high-speed and large-capacity communication in which the drive unit is used can be realized by applying the light transmitting module 204 to the drive unit.

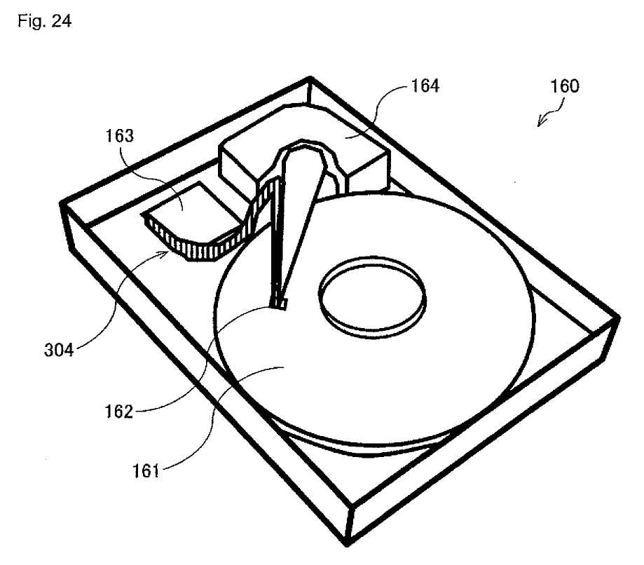

FIG. 24 shows an example in which the light transmitting module is applied to a hard disk recording and reproducing apparatus. In such cases, preferably the flexibility is imparted to the optical waveguide (optical transmission line) of the light transmitting module.

As shown in FIG. 24, a hard disk recording and reproducing apparatus 160 includes a disk (hard disk) 161, a head (reading and writing head) 162, a board introduction unit 163, a drive unit (drive motor) 164, and a light transmitting module 304.

The drive unit 164 drives the head 162 along a radial direction of the disk 161. The head 162 reads information recorded on the disk 161, and writes the information on the disk 161. The head 162 is connected to the board introduction unit 163 through the light transmitting module 304. The head 162 transfers the information read from the disk 161 to the board introduction unit 163 in the form of the optical signal. The head 162 receives the optical signal of the information written on the disk 161, and the information written on the disk 161 is transferred from the board introduction unit 163.

Thus, the high-speed and large-capacity communication can be realized by applying the light transmitting module 304 to the drive unit such as the head 162 of the hard disk recording and reproducing apparatus 160.

Thus, the light emitting element circuit according to one or more embodiments of the present invention includes the light emitting element, the drive circuit which supplies the current to the light emitting element, and the signal circuit which autonomously supplies the signal according to an ambient temperature, and the light emitting element circuit is characterized in that the signal adjusts the current such that the current corresponds to the temperature characteristic of the light emitting element.

According to the configuration, because the signal can set the current supplied to the light emitting element to the value suitable to the temperature characteristic of the light emitting element, the excessive margin can be reduced to realize the low power consumption. Because the signal circuit autonomously supplies the signal, the feedback circuit, the computation processing circuit, and the memory circuit can be eliminated to further achieve the low power consumption and the compact module.

Preferably the signal circuit includes the circuit element whose element characteristic is changed by the temperature. Therefore, the compact size and the power saving can be achieved in the signal circuit. The circuit element may be either the transistor or the resistor. In such cases, the signal circuit may be configured while including the plural kinds of transistors having different temperature characteristics, the signal circuit may be configured while including the plural kinds of resistors having different temperature characteristics, or the signal circuit may be configured while including the transistor having the temperature characteristic and the resistor having the temperature characteristic. Further, the signal circuit can also be configured while including the temperature sensor.

In the light emitting element circuit, the signal may be an electric signal which is linearly changed with respect to a temperature, or the signal may be an electric signal which is gradually increased with respect to a temperature.

The light transmitting system according to one or more embodiments of the invention includes the light emitting element circuit, and the light transmitting system is characterized in that the light emitting element is a data transmitting light emitting element, and the current includes at least one of a modulation current and a bias current. Therefore, the compact size and low power consumption can be realized in the light transmitting system.

In the light transmitting system, the current may include the modulation current and the bias current. In such cases, preferably the signal adjusts the modulation current and bias current such that the modulation current and bias current correspond to a temperature characteristic of the light emitting element, respectively. Therefore, the modulation current and bias current supplied to the light emitting element can respectively be adapted to the temperature characteristic of the light emitting element, so that the excessive margin can be reduced to further realize the low power consumption.

In the light transmitting system, the signal circuit may include the first signal circuit which autonomously supplies the first signal according to an ambient temperature; and the second signal circuit which autonomously supplies the second signal according to an ambient temperature, the first signal may adjust the modulation current such that the modulation current corresponds to the temperature characteristic of the light emitting element, and the second signal may adjust the bias current such that the bias current corresponds to the temperature characteristic of the light emitting element. Therefore, the modulation current and bias current supplied to the light emitting element can respectively be adapted to the temperature characteristic of the light emitting element, so that the excessive margin can be reduced to further realize the low power consumption.

In the light transmitting system, the signal circuit may include the first signal circuit which autonomously supplies the first signal according to an ambient temperature, the first signal may adjust the modulation current such that the modulation current corresponds to a temperature characteristic of the light emitting element, and the feedback adjustment may be performed to the bias current based on an output of the light emitting element.

In the light transmitting system, a VCSEL (Vertically Cavity Surface Emitting Laser) can be used as the light emitting element. In such cases, in the VCSEL, the cavity length is set such that the threshold current is linearly increased with respect to the temperature.

The light transmitting module according to one or more embodiments of the present invention is characterized by including the light transmitting system and the optical data receiving light acceptance element.

The light transmitting module according to one or more embodiments of the present invention includes the optical data transmitting light emitting element; the drive circuit which supplies the current to the light emitting element; the optical data receiving light acceptance element; and the signal circuit which autonomously supplies the signal according to an ambient temperature, and the light transmitting module is characterized in that the signal adjusts the current such that the current corresponds to the temperature characteristic of the light emitting element and the temperature characteristic of the light acceptance element.

According to the configuration, the current supplied to the light emitting element can be adapted by the signal to the temperature characteristic of the light acceptance element and the temperature characteristic of the light emitting element, so that the excessive margin can be reduced to further realize the low power consumption. Because the signal circuit autonomously supplies the signal, the feedback circuit, the computation processing circuit, and the memory circuit can be eliminated to further achieve the low power consumption and the compact module.

The light transmitting module according to one or more embodiments of the present invention includes the first optical module which includes the light emitting element circuit of an first aspect; the optical transmission line; and the second optical module which includes the optical data receiving light acceptance element, and the light transmitting module is characterized in that the first optical module is provided in one of end portions of the optical transmission line and the second optical module is provided in the other end portion of the optical transmission line. In such cases, the optical transmission line may be an optical waveguide, and the optical waveguide may be a polymer waveguide. The optical waveguide may have flexibility.

The electronic device according to one or more embodiments of the present invention is characterized by including the light transmitting module.

The present invention is not limited to the above-described embodiments, but various modifications can be made without departing from the scope of the invention. That is, the technical scope of the present invention includes an embodiment obtained by a combination of technical means which are appropriately changed without departing from the scope of the invention.

### INDUSTRIAL APPLICABILITY

The light emitting element circuit according to one or more embodiments of the present invention and the light transmitting module provided therewith are suitable to the electronic devices such as the portable telephone, the printer, and the hard disk.

1. A light emitting element circuit comprising including:
a light emitting element;
a drive circuit that supplies a current to the light emitting element; and
a signal circuit that autonomously supplies a signal according to an ambient temperature,
wherein the signal adjusts the current such that the current corresponds to a temperature characteristic of the light emitting element.

2. The light emitting element circuit according to claim 1, wherein the signal circuit is operable to autonomously supply the signal by including at least one circuit element whose element characteristic is changed by an ambient temperature.

3. The light emitting element circuit according to claim 2 wherein the circuit element is a transistor.

4. The light emitting element circuit according to claim 2, wherein the circuit element is a resistor.

5. The light emitting element circuit according to claim 1, wherein the signal is an electric signal that linearly increases with respect to temperature.

6. The light emitting element circuit according to claim 1, wherein the signal is an electric signal that gradually increases with respect to temperature.

7. The light emitting element circuit according to claim 1, wherein the signal circuit comprises a temperature sensor.

8. A light transmitting system comprising the light emitting element circuit according to claim 1, wherein
the light emitting element is a data transmitting light emitting element, and
the current comprises at least one of a modulation current and a bias current.

9. The light transmitting system according to claim 8, wherein the current comprises the modulation current and the bias current.

10. The light transmitting system according to claim 9, wherein the signal adjusts the modulation current and bias current such that the modulation current and bias current correspond to the temperature characteristic of the light emitting element.

11. The light transmitting system according to claim 9, wherein the signal circuit comprises:
a first signal circuit that autonomously supplies a first signal according to an ambient temperature; and
a second signal circuit that autonomously supplies a second signal according to an ambient temperature,
the first signal adjusts the modulation current such that the modulation current corresponds to the temperature characteristic of the light emitting element, and
the second signal adjusts the bias current such that the bias current corresponds to the temperature characteristic of the light emitting element.

12. The light transmitting system according to claim 9, wherein the signal circuit comprises a first signal circuit that autonomously supplies a first signal according to an ambient temperature,
the first signal adjusts the modulation current such that the modulation current corresponds to the temperature characteristic of the light emitting element, and
feedback adjustment is performed to the bias current based on an output of the light emitting element.

13. The light transmitting system according to claim 9, wherein the light emitting element is a VCSEL.

14. The light transmitting system according to claim 13, wherein, in the VCSEL, a cavity length is set such that a threshold current is linearly increased with respect to a temperature.

15. A light transmitting module comprising:
the light transmitting system according to claim 9; and
an optical data receiving light acceptance element.

16. A light transmitting module comprising:
an optical data transmitting light emitting element;
a drive circuit that supplies a current to the light emitting element;
an optical data receiving light acceptance element; and
a signal circuit that autonomously supplies a signal according to an ambient temperature,
wherein the signal adjusts the current such that the current corresponds to a temperature characteristic of the light emitting element and a temperature characteristic of the light acceptance element.

17. A light transmitting module comprising:
a first optical module comprising the light emitting element circuit according to claim 1;
an optical transmission line; and
a second optical module comprising an optical data receiving light acceptance element,
wherein the first optical module is provided in one of end portions of the optical transmission line, and the second optical module is provided in the other end portion of the optical transmission line.

18. The light transmitting module according to claim 17, wherein the optical transmission line is an optical waveguide.

19. The light transmitting module according to claim 18, wherein the optical waveguide is a polymer waveguide.

20. The light transmitting module according to claim 18, wherein the optical waveguide has flexibility.

21. An electronic device comprising the light transmitting module according to claim 17.
